(19) United States
(12) Patent Application Publication
(10) Pub. No.: US 2006/0143656 A1
(43) Pub. Date: Jun. 29, 2006

(54) Program display and selecting apparatus, digital broadcast receiver and digital broadcast receiving system

(75) Inventors: Yoshifumi Sakamoto, Konan-Shi (JP); Hiroaki Kubo, Ohmihachiman-shi (JP); Norio Fujita, Shiga-ken (JP)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/358,280

(22) Filed: Feb. 21, 2006

Related U.S. Application Data
(63) Continuation-in-part of application No. 09/491,467, filed on Jan. 26, 2000.

(30) Foreign Application Priority Data
Jan. 28, 1999 (JP) 11-019896

(51) Int. Cl. H04N 5/445; G06F 3/00; G06F 13/00

(52) U.S. Cl. 725/47; 725/44; 725/39

(57) ABSTRACT

A program display and selecting apparatus for displaying an electronic program guide (EPG) contained in a digital broadcast and for selecting a program to be monitored, a digital broadcast receiver for transmitting an EPG to the program display and selecting apparatus, and a digital broadcast receiving system comprising the program and selecting apparatus and the digital broadcast receiver.

### CROSS-REFERENCE TO RELATED APPLICATION

This application is a continuation-in-part application of U.S. Ser. No. 09/491,467; filed on Jan. 26, 2000.

### BACKGROUND OF THE INVENTION

1. Field of the Invention

The present invention relates to a program display and selecting apparatus for displaying an electronic program guide (EPG) contained in a digital broadcast and for selecting a program to be monitored, a digital broadcast receiver for transmitting an EPG to the program display and selecting apparatus, and a digital broadcast receiving system comprising the program and selecting apparatus, and the digital broadcast receiver, wherein the components consisting of the various apparati are discrete and separate from each other so as to be readily interchangeably replaceable.

2. Discussion of the Prior Art

In analog broadcasting, only one channel can be allotted to one frequency band, whereas a plurality of channels can be allotted to one frequency band in digital broadcasting. Consequently, digital broadcasting can be utilized to implement a multi-channel system more readily than can analog broadcasting. Digital broadcasting now includes the aspects of communications satellite (CS) broadcasting, cable broadcasting, Internet broadcasting, and the like broadcasting technologies. All of the receivers for these types of broadcasting are normally of set-top box type, as shown in FIG. 6. The set-top box 90, which is an apparatus connected to a television monitor 70, has a function of receiving and converting an image signal and a connecting interface for implementing the connecting with a telephone circuit or a personal computer.

The digital broadcast receiver 90 shown in FIG. 6 includes a digital input (receiving cable 96), a television output (output cable 74) and a remote control interface (I/F) (receiving unit 108). A program selected by a user from among the broadcast programs input through the output cable 74 is outputted on the monitor screen 72 of the television 70 through the output cable 74. A program is selected through the use of infrared remote control apparatus 92 having a transmission unit 118, or by operating buttons on the main body of the receiver 90.

In digital broadcasting represented by Communications Satellite (CS) broadcasting, cable broadcasting and the like, such data as representing an image, sound and compute program is compressed in accordance with Moving Picture Expert Group Phase 2 (MPEG2), and the mixed data is transmitted in accordance with MPEG2-TS (transport stream). The MPEG2-TS contains the electronic program guide called EPG, in addition to the program.

As shown in FIG. 7, the digital broadcast receiver 90 includes:

a tuner unit 64 for receiving data;

an MPEG2 transport demultiplexer 62 for transmitting the program data from the tuner 64 to an MPEG2 decoder and image processor 102 and for transmitting EPG information (program table) to a microprocessor unit (MPU) 104;

an MPEG2 decoder and image processor 102 for obtaining the program image and sound data from the received MPEG2 data as well as for synthesizing the EPG information processed by the MPU 104 wit the program data; and

an NTSC (National Television System Committee) encoder and audio 68 for outputting the program data and the EPG information to the television 70.

The program data is received by the tuner unit 64 and then transmitted as a digital data to the MPEG2 transport demultiplexer 62. The program image and sound data are transmitted from the transport demultiplexer 62 to the NTSC encoder and audio 68 through the MEPG2 decoder and image processor 102 and then outputted to the television 70 as an analog image and sound output. The EPG information is, as shown in FIG. 8, transmitted from the transport demultiplexer 62 to the MPU 104 (arrow A in FIG. 8). After being processed by the MPU 104, it is transmitted to the MPEG2 decoder and image processor 102 (arrow B in FIG. 8). After being subjected to image processing, it is displayed on the television monitor screen 72.

The digital broadcast receiver 90 including an infrared interface 106 and the infrared receiving unit 108, which are connected to the MPU 104, can receive a signal from the remote control apparatus 92 and input the signal to the MPU 104. A program channel displayed on the television 70 is selected by controlling the demultiplexer 62 by the MPU 104. Also, the program table is switched on or off by controlling the MPEG2 decoder and image processor 102 by the MPU 104.

As shown in FIG. 7, the remote control apparatus 92 includes a switch button 112, a switch button interface 114, an infrared transmitting unit 118 and an infrared interface 116 for transmitting the input switch button information to the receiver unit 90. When the switch button is pressed, the input information is transmitted to the MPU 104 of the receiver 90.

For example, when a remote control apparatus 92 is equipped with switch buttons corresponding to the channel numbers and one of the buttons is pressed, the information of the pressed button is transmitted to the MPU 104. The MPU 104 controls the transport demultiplexer 62 (arrow A in FIG. 9) and switches the program to be received by the tuner 64 to a channel corresponding to the pressed button.

As a further example, when the switch button for switching the program table display on/off on the remote control apparatus 92 is pressed in the non-display status of the program table, the information that a button has been pressed is transmitted to the MPU 104. The MPU 104 transmits an EPG information (arrow B in FIG. 9) to the MPEG2 decoder and image processor 102 and displays the program table after image processing the information.

The EPG (program table) includes information concerning a broadcasting program such as channel number, channel name, program name, date of a program, start time of a program, program code, program description and so on. For example, as shown in FIG. 11 to FIG. 13, such information as messages and program tables are provided to the users by displaying the information of each program in the program frames 82 and 84 and by displaying a description for the selected program 84 in the description frame 86. Referring to the EPG information 78 displayed on the monitor screen 72, the users are able to select a program to monitor with the remote control apparatus 92.

A monitor screen for EPG display is used to display an EPG information 78, or the EPG information 78 may often be superposed on a program image 76. However, in these cases, almost all the area of the monitor screen 72 is occupied by the EPG information 78. To describe patterns for EPG display more precisely, for example, FIG. 10 shows a program image 76 before displaying an EPG information. In FIG. 11, the EPG information 78 is displayed on a full screen. In 12, the EPG information 78 is superposed on the program image 76, and in FIG. 13, the program image 76 is displayed on the compressed monitor frame 88.

In the case of displaying the EPG information 78 on a full screen 72 of the television 70 as shown in FIG. 11, only the EPG information 78 is displayed on the screen, so that the program image 76 in the receiving cannot be monitored. Unlike the above case in FIG. 11, in the case of displaying the EPG by superposing the EPG 78 on the program image 76 as shown in FIG. 12, only a small part of the program image 76 in the receiving can be monitored from between the gaps of the program table 78. However, the program image 76 can hardly be monitored in a sufficient mode. In some cases, the EPG information may be superposed on the program image 76 as a translucent or see-through image through which the program image 76 can be seen. However, again, although it is possible to monitor the program image 76 between the gaps and through the translucent EPG image, it is hard to monitor the program. Also, since the program image 76 is visible through the program table 78, it is hard to read the characters on the program table 78.

In the case of FIG. 13, the image 76 being received is compressed and displayed in a part of the monitor screen 72 of the television 70 (compressed monitor screen 88) and the EPG information 78 is displayed in the remaining area of the monitor screen. Since the program image 76 is compressed, the image 76 of FIG. 13 is inferior to the normal image shown in FIG. 10. As described above, when the EPG information 78 is displayed on the television monitor screen 72, the users are interrupted in monitoring a program or made it hard to monitor a program.

The digital broadcast receiver receives the EPG information for channels in the same frequency band as that currently being received once every 10 seconds and the EPG information for channels in different bands from the current band once every 30 seconds. Therefore, for example, assuming that there are 200 channels and 4 channels are included in one frequency band and that frequency or channel is changed to capture the EPG for the 200 channels (4 channels×50 bands) sequentially, one channel for each band, it will take 10 seconds×50=500 seconds (8 minutes and 20 seconds), 10 seconds per band. In order to capture the EPG information for the 200 channels, one channel for each band, without changing the frequency or channel, it will take 30 seconds×50=1500 seconds (25 minutes) 30 seconds per band.

In the case of an actually commercialized CS receiver, whenever a screen displaying EPG information is scrolled, it is necessary to capture new EPG information to display again after scrolling. Therefore, if the screen is scrolled while EPG information is being obtained one after another under the same conditions described above, it will take a maximum latency of 10 seconds for one row (for one channel). Thus, if EPG information is received every time it is displayed on a television screen, it takes longer time to display and renew the information and it is impossible to provide the newest EPG information constantly to users.

Although publications are presently known which disclose generally the type of program display and selecting apparatus for displaying an electronic program guide contained in a digital broadcast for selecting a program which is to be monitored, these fail to provide for the advantages accorded by the present invention.

Darbee, et al., U.S. Pat. No. 6,130,726, illustrate a display on a remote control hand-held unit whereby scrolls of a program guide information may be shown on a small display surface, or alternatively, possibly a pictorial display may be superimposed thereon thereby concurrently blocking viewing access to the particular program guide.

Although a program drive in Darbee, et al. is displayed on a remote control display, this is essentially a portion of a remote unit, preferably such as a handheld controller, and does not facilitate the transmission of the EPG data from a digital broadcast receiver to a program display and selection apparatus which is remote therefrom through the intermediary of an IR transmitter and receiver unit and which enables the selection of a program and outputting thereof onto the TV screen of a TV monitor.

Donnelly, U.S. Pat. No. 6,460,181 B1, discloses a function which is similar to the present invention only in that both Donnelly and the present invention are directed to updating real time EPG data in order to implement a program navigation. However, a number of aspects distinguish Donnelly from the present invention. In particular, in Donnelly the EPG data is displayed directly on the TV monitor screen whereby the scrolling of the EPG data will interrupt the programming for predetermined periods of time a manner which is considered to be extremely annoying to a viewer since it vents the continuous viewing of a particular program during the periods when the EPG data is displayed on the television monitor screen. Furthermore, in Donnelly the EPG data is never transmitted to another device from the digital broadcast receiver but is always directly displayed on the TV monitor screen, thereby interrupting the display of a TV program which is currently being watched by a viewer as a result of the display of the TV program navigation incorporating the EPG data. This type of interruption of a TV program in order to determine other programs from EPG data is never encountered in the present invention contrary to the Donnelly function and structure. Huang, et al., U.S. Pat. No. 6,437,836 B1, is only similar to the invention at a point in operation where a TV program is selected from a program table utilizing a palm device, the acquisition procedure is different from that of receiving EPG data from the digital broadcast receiver pursuant to the invention.

### SUMMARY OF THE INVENTION

An object of the present invention is to provide a digital broadcast receiving system having a program display and selecting apparatus and a digital broadcast receiver, which can display a program table (or EPG) without preventing the monitoring of a program image, provide a means for directly selecting a program to be monitored, and further provide the newest program tables constantly to users.

An essential part of the digital broadcast receiver of the present invention is to include a transmitting means for transmitting the EPG data contained in a received digital broadcast data. An essential part of the program display and selecting apparatus of the present invention is to include a receiving means for the EPG data transmitted from said digital broadcast receiver and a displaying means for displaying the received EPG data.

These apparati are constituted of separate and readily interchangeable and replaceable components to thereby impart a versatility and highly economical attribute thereto. Each separate apparatus can be replaced by a similar component in correlation with particular operative requirements, and portions, such as the TV monitor, for example, selectively operated without one or more of the other apparatus units.

### BRIEF DESCRIPTION OF THE DRAWINGS

Preferred embodiments of the present invention will now be described by way of example only, with reference to the accompanying drawings in which:

FIG. 1 is a perspective view illustrating an outline of a program display and selecting apparatus, and a digital broadcast receiver according to the present invention.

FIG. 2 is a block diagram showing a structure of the program display and selecting apparatus, and the digital broadcast receiver shown in FIG. 1.

FIG. 3 is an enlarged view of the program display and selecting apparatus shown in FIG. 1.

FIG. 4 is a block diagram illustrating a flow of an EPG information through the program display and selecting apparatus shown in FIG. 1.

FIG. 5 is a block diagram illustrating a flow of a program selecting information through the program display and selecting apparatus shown in FIG. 1.

FIG. 6 is a perspective view illustrating an outline of a conventional remote control apparatus and a digital broadcast receiver.

FIG. 7 is a block diagram showing a structure of the remote control apparatus and the digital broadcast receiver shown in FIG. 6.

FIG. 8 is a block diagram illustrating a flow of EPG information through the remote control apparatus and the digital broadcast receiver shown in FIG. 6.

FIG. 9 is a block diagram illustrating a flow of a program selecting information through the remote control apparatus and the digital broadcast receiver shown in FIG. 6.

FIG. 10 is a partially enlarged view showing an example of a monitor screen displaying a program image on the television shown in FIG. 6.

FIG. 11 is a partially enlarged view showing an example of a monitor screen displaying a program table on the television shown in FIG. 6.

FIG. 12 is a partially enlarged view showing another example of a monitor screen displaying a program table on the television shown in FIG. 6.

FIG. 13 is a partially enlarged view showing still another example of a monitor screen displaying a program table on the television shown in FIG. 6.

### DETAILED DESCRIPTION OF THE PREFERRED EMBODIMENTS

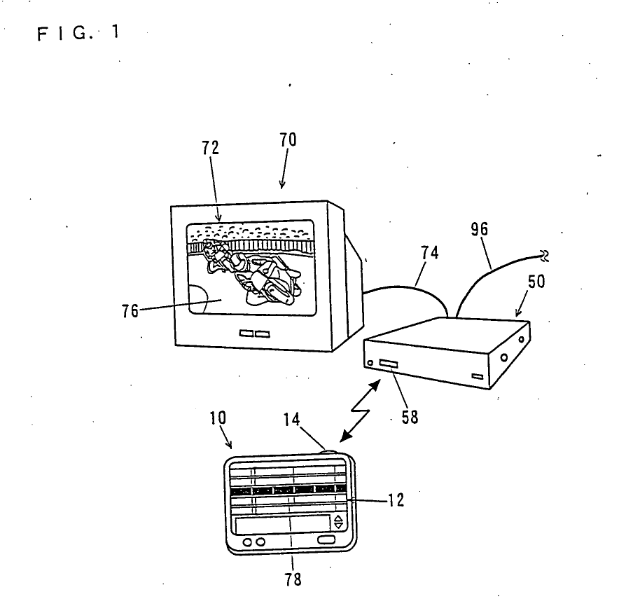

Referring now to the accompanying drawings, embodiments of broadcast receiving system including a program display and selecting apparatus and a digital broadcast receiver are described below. FIG. 1 shows a program display and selecting apparatus 10 and a digital broadcast receiver 50 according to the present invention. The program display and selecting apparatus 10 comprises a liquid crystal display (LCD) 12 and an infrared transmitter-receiver unit 14. The digital broadcast receiver 50 comprises an infrared transmitter-receiver unit 58. The transmitter-receiver units 14 and 58 comprise a transmitter element and a receiver element, respectively (not shown).

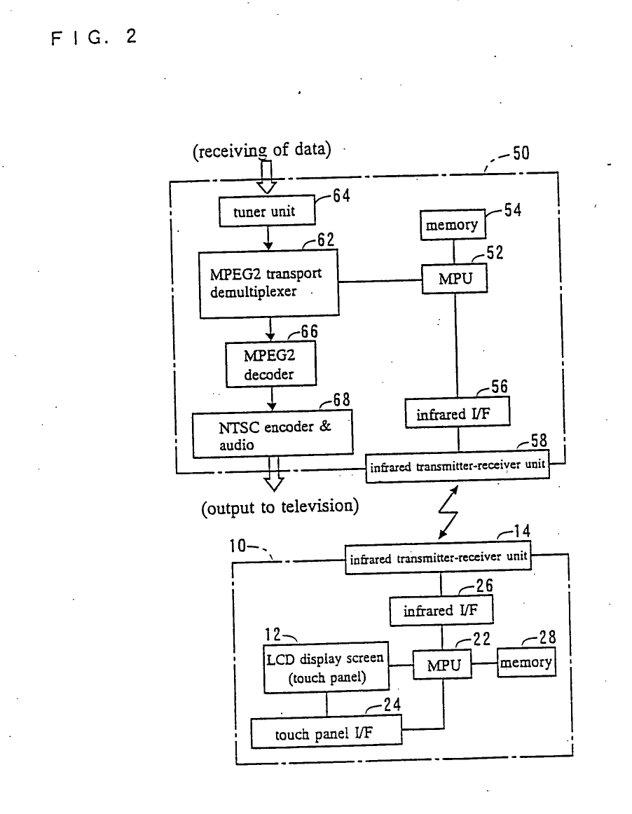

FIG. 2 is a schematic block diagram showing a structure of the program display and selecting apparatus 10 and the digital broadcast receiver 50. The digital broadcast receiver 50 comprises a memory 54 for storing EPG information processed by an MPU 52, a transmitter-receiver unit 58 and an infrared interface 56, which transmit data to and receive data from the program display and selecting apparatus 10. Further, like a conventional digital broadcast receiver, the digital broadcast receiver 50 comprises a tuner unit 64, an MPEG2 transport demultiplexer 62, an MPEG2 decoder 66 for obtaining image and sound data from received MPEG2 data, and NISC encoder and audio 68, and it is connected to a receiving cable 96 and an output cable 74.

The program display and selecting apparatus 10 comprises a transmitter-receiver unit 14 and an infrared interface 26 which transmit data to and receive data from the digital broadcast receiver 50, an MPU 22, a memory 28 for storing EPG information transmitted from the digital broadcast receiver 50 and an LCD 12 for displaying EPG information. The screen surface of the LCD 12 is a touch panel, which allows users to manipulate input operation with a pen or finger. Thus, a program to be monitored can be selected through the touch panel.

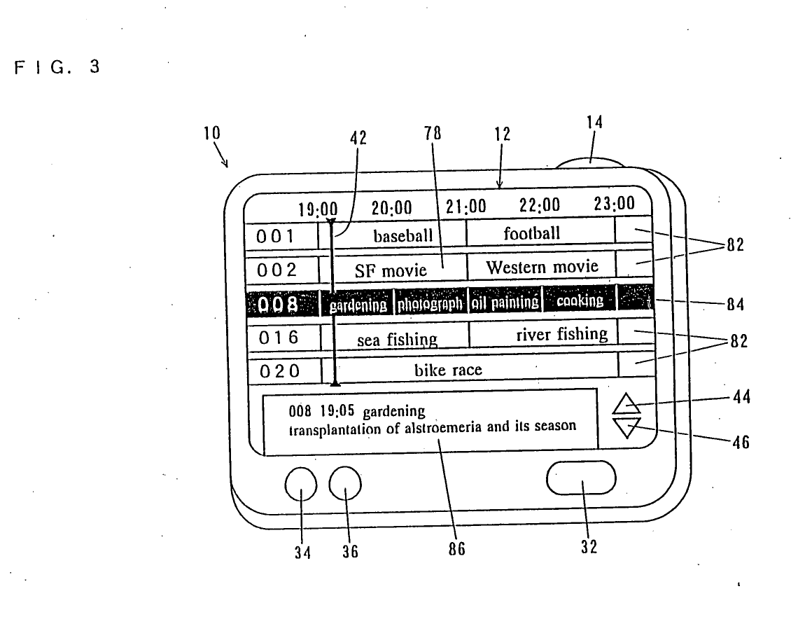

FIG. 3 is a front view of the program display and selecting apparatus 10. A program table 78, operation marks 44 and 46, a present time line 42 indicating present time and the like are displayed on the LCD screen 12. The program table 78, for example, includes program frames 82 and 84, which indicate content of program on each channel, and a description frame 86, which displays a program description of a selected channel 84. The operation marks 44 and 46 allow the users to scroll up or down the program frames 84 and 82 by touching the mark 44 or 46, for example. In addition, the program display and selecting apparatus 10 can be equipped with operation buttons 32, 34 and 36. For example, these operation buttons can be push button type switches. In this case, the power may be turned on/off by pressing button 32, the sound output level of television image may be reduced by pressing button 34, and sound output level may be increased by pressing button 36.

Next, a functional description of the program display and selecting apparatus when a program is monitored by using the apparatus is given below. Like in the conventional manner, program data is transmitted to the television 70 through the tuner unit 64, the MPEG2 transport demultiplexer 62, the MEPG2 decoder 66 and the NTSC encoder and audio 68.

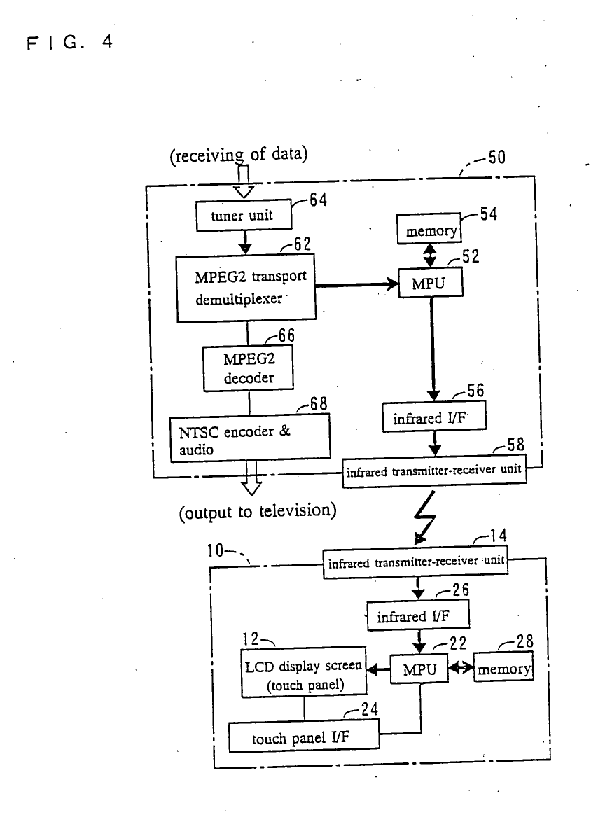

As shown in FIG. 4, EPG information is transmitted from the transport demultiplexer 62 to the MPU 52. After being processed by the MPU 52, the EPG information is stored temporarily in the memory 54. The EPG information stored in the memory 54 is transmitted from the digital broadcast receiver 50 to the EPG display and selecting apparatus 10 through the infrared I/F 56 and the infrared transmitter-receiver unit 58, after it is further processed or as it is. The EPG information is transmitted whenever the digital broadcast receiver 50 receives a newest EPG information. Further, since the program displayed selecting apparatus 10 is not always ready to receive the EPG information, the digital broadcast receiver 50 repeats the transmission of the EPG information periodically.

In the program displayed selecting apparatus 10, the EPG information is received by the infrared transmitter-receiver unit 14 and the infrared I/F 26. The receiver EPG information is transmitted to and stored in the memory 28 through the MPU 22. Then, the EPG information (program table) stored in the memory 28 is transmitted through the MPU 22 again and displayed on the LCD monitor screen.

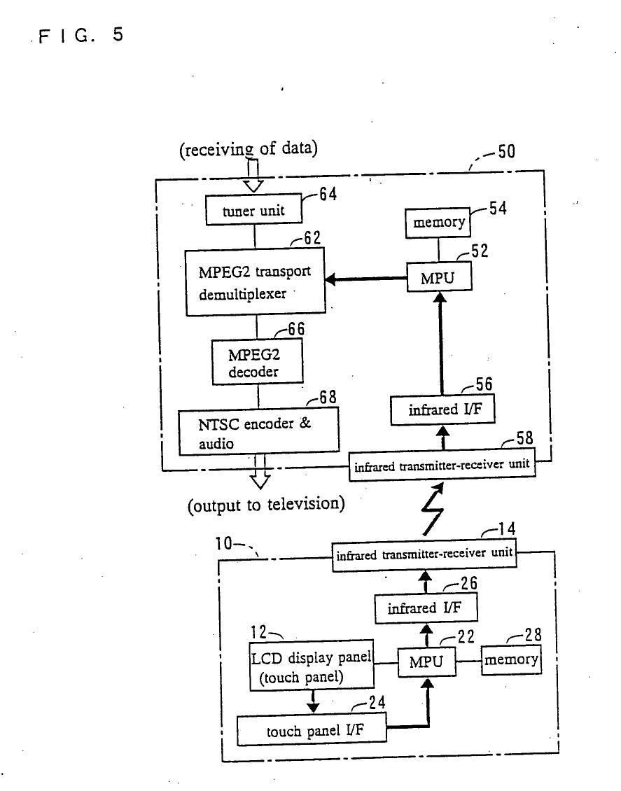

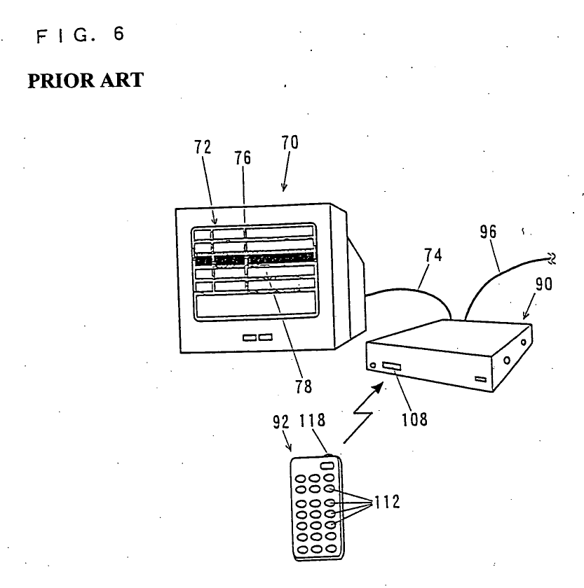

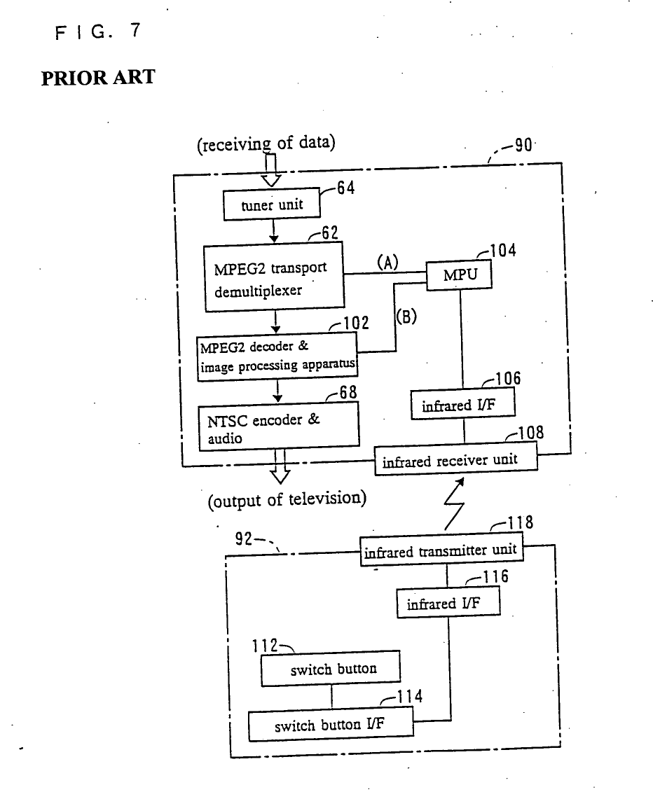

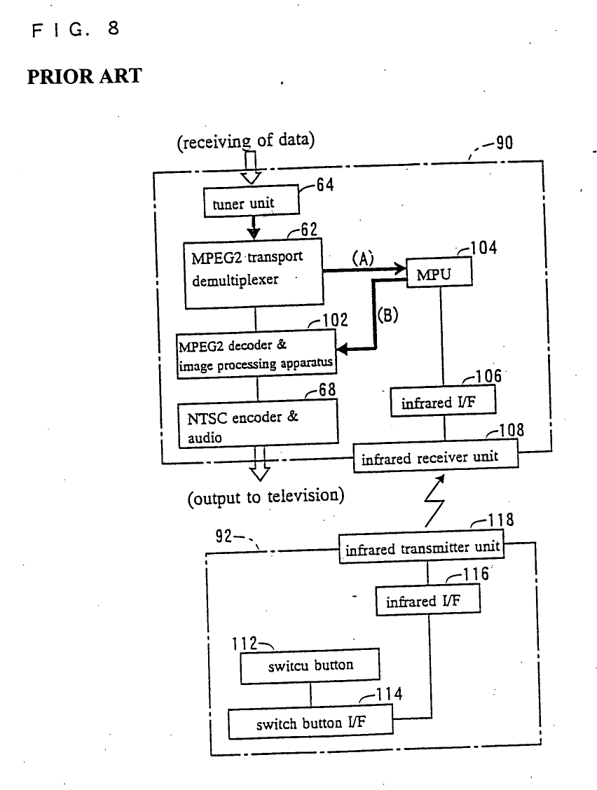

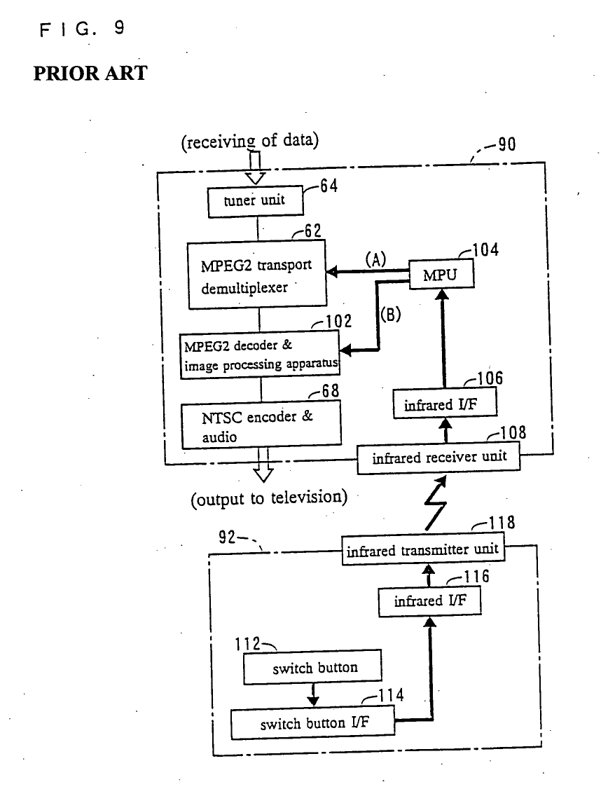

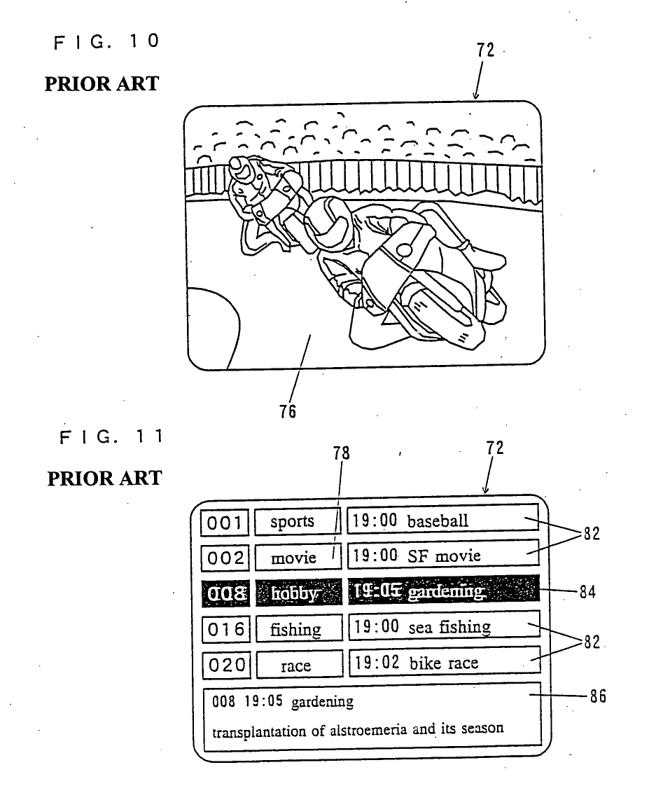

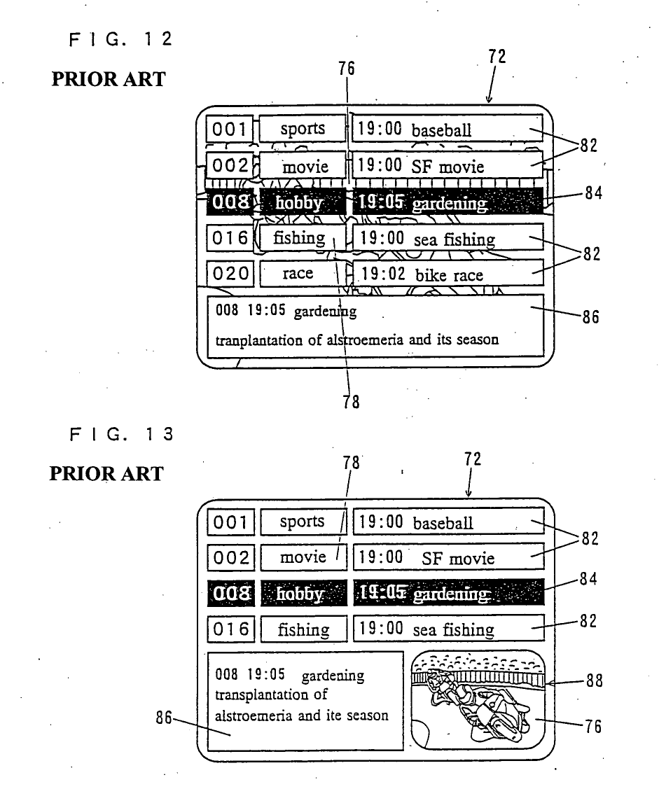

When selecting a program to monitor, a user can select a desired program by touching the LCD monitor screen (touch panel) 12 with his/her finger. Information of the selected program is transmitted from the touch panel to the MPU 22 through the touch panel I/F 24 as shown in FIG. 5. Then, the information of the selected program is further transmitted from the infrared I/F 26 and the infrared transmitter-receiver unit 14 to the digital broadcast receiver 50.

In the digital broadcast receiver 50, the information of the selected program received by the infrared transmitter-receiver unit 58 and the infrared I/F 56 is transmitted to the MPU 52. The MPU 52 controls the transport demultiplexer 62 and switches a program received by the tuner 64 to the selected program.

As described above, the program displayed and selecting apparatus 10 comprising a display means eliminates the need for displaying EPG information on the television monitor screen 72, therefore, users are not prevented from monitoring a program. Furthermore, periodical transmutation of EPG information enables users to obtain EPG information constantly. Especially in the conventional manner, whenever EPG information is displayed on the television monitor screen 72, EPG information has to be received, therefore, it takes a considerable period of time to renew the display. However, by using the apparatus 10 of the present invention, the latest EPG information can always be displayed. Furthermore, a user can directly select a program displayed on the television 70 among the EPG information displayed on the touch panel 12 by touching the panel 12 with his or her finger.

The EPG (electronic program guide) data received in the program display and selecting apparatus 10 from the digital broadcast receiver 50 facilitates the selection of a program on a monitor screen of a separate television monitor which facilitates the outputting of the program on the television monitor screen in the absence of any display interruption caused by the EPG data. In essence, the EPG data is displayed on a program table 78, preferably through an LCD display 12 on a monitor screen of the program display and selection apparatus 10 which is remote and separate from the digital broadcast receiver 50 and which is able to provide for a selection of programs through a TV output cable 74 to the monitor screen 72 of the TV monitor without interruption of any kind of the program being broadcast on that screen.

The foregoing function and components of the digital broadcast receiving system which uses the advantageously separate and individually replaceable constituents constituted of the digital broadcast receiver 50, the program display and selection apparatus 10 and the TV monitor 70 is not at all disclosed in the art.

Thus, an important and unique aspect of the present invention resides in the EPG data initially through the digital broadcast receiver 50, whereby the EPG data is then handled and processed in the separate program display and selection apparatus 10 so as to be able to select a programs for a further separate TV monitor 70 without interrupting a program which is presently being watched on the screen while enabling a viewer to ascertain other programs which may be of interest to him or her.

Having described the preferred embodiments of the present invention, it should be understood that the program display and selecting apparatus, the digital broadcast receiver and the digital broadcast receiving system according to the present invention can also be materialized in other embodiments in view of the separate modular constructions thereof. For example, data transmission between the program displayed and selecting apparatus and the digital broadcast receiver can be replaced with a data transmission with an IR-Bus (excepting infrared rays), a radio (radio wave) or the like. Further, the operation means (or touch panel) for operating the digital broadcast receiver is not limited to selecting a channel, but it can also make a program reservation.

Based on the accompanying drawings, practical embodiments of the program display and selecting apparatus, the digital broadcast receiver and the digital broadcast receiving system according to the present invention have been described above, however, the present invention is not limited to the illustrated program display and selecting apparatus and the digital broadcast receiver. For example, the operating means is not limited to the touch panel. Operation keys or a pointing device such as a joystick, a mouse or the like can be used as the operating means. Further, the program display and program selection may also be performed by using a personal computer equipped with an IR (infrared) transmitter-receiver interface. Accordingly, it will be apparent to those skilled in the art that various changes, improvements, and modifications can be made thereto without departing from the spirit or scope of the invention.

According to the program display and selecting apparatus, the digital broadcast receiver and the digital broadcast receiving system of the present invention, using a program display and selecting apparatus, which can communicate with a digital broadcast receiver, EPG information can be displayed on the apparatus while a program is monitored. In addition, the newest EPG information (program table) can always be provided to users. Furthermore, a desired program display and selecting apparatus with a pen or a user's finger.

While the invention has been particularly shown and described with respect to preferred embodiments thereof, it will be understood by those skilled in the art that the foregoing and other changes in form and detail may be made therein without departing from the spirit and scope of the invention.

What is claimed is:

1. A digital broadcast receiving system consisting of separate and interchangeable modular components including a television monitor having a monitor screen for displaying selected programs comprising:
a separate digital broadcast receiver having an infrared receiving and transmitting means for transmitting electronic program guide (EPG) data contained in a received digital broadcast data;
a program display and selecting apparatus which is separately constituted and remote from said digital broadcast receiver having a receiving means comprising an infrared receiver and transmitter unit for receiving the EPG data transmitted from said infrared receiving and transmitting means of said digital broadcast receiver;
said program display and selecting apparatus comprising a displaying means for concurrently displaying the received EPG data; said digital broadcast receiver periodically transmitting EPG data; and
said program display and selecting apparatus comprises an operation means for operating said digital broadcast receiver, wherein the EPG data received from said digital broadcast receiver facilitates selection of a program for outputting thereof on said television monitor screen, in the absence of any display interruption caused by said EPG data, based upon the EPG data information which has been received.

2. The digital broadcast receiving system according to claim 1, wherein said program display and selecting apparatus comprises a transmitting means for transmitting operational information inputted into said operation means to said digital broadcast receiver; and
said digital broadcast receiver comprises a receiving means for receiving the operational information transmitted from said program display and selecting apparatus.

3. The digital broadcast receiving system according to claim 1, wherein said operation means comprises a touch panel.

4. The digital broadcast receiving system according to claim 1, wherein said operation means selects a program to be monitored.

5. A digital broadcast receiver comprising a transmitting means for transmitting EPG data contained in a received digital broadcast data; a program display and selecting apparatus separate and remote from said digital broadcast receiver and including a receiving means for receiving EPG data transmitted from the digital broadcast receiver; said program display and selecting apparatus comprising a display means for concurrently displaying said received EPG data, wherein the EPG data received from said digital broadcast receiver facilitates selection of a program for an uninterrupted outputting thereof on a monitor screen of a television monitor based upon the received EPG data information.

6. The digital broadcast receiver according to claim 5, wherein said program display and selecting apparatus comprises operation means communicating with a transmitting means for transmitting the operational information input to said digital broadcast receiver.

7. The digital broadcast receiver and program display and selecting apparatus according to claim 6, wherein said operation means comprises a touch panel.

8. The digital broadcast receiver and program display and selecting apparatus according to claim 6, wherein said operation means selects a program to be monitored.

9. The digital broadcast receiver and program display and selecting apparatus according to claim 6, wherein said transmitting means transmits EPG data contained in a received digital broadcast data and said broadcast receiver includes a receiving means for receiving the operational information transmitted from the program display and selected apparatus.
